(19) United States
(12) Patent Application Publication
(10) Pub. No.: US 2021/0133154 A1
(43) Pub. Date: May 6, 2021

(54) FILESYSTEMS

(71) Applicant: VORTEIL.IO PTY LTD, Varsity Lakes (AU)

(72) Inventor: Alan Keith Murtagh, Arundel (AU)

(21) Appl. No.: 17/049,568

(22) PCT Filed: Apr. 24, 2019
(86) PCT No.: PCT/AU2019/000047

§ 371 Date: Oct. 21, 2020

(30) Foreign Application Priority Data
Apr. 24, 2018 (AU) 2018901355
Aug. 21, 2018 (AU) 2018903071

(51) Int. Cl. G06F 16/188; G06F 16/14; G06F 16/18; G06F 16/182; G06F 3/06

(52) U.S. Cl. CPC G06F 16/188; G06F 16/14; G06F 16/1858; G06F 3/0607; G06F 3/064; G06F 3/067; G06F 16/1827

(57) ABSTRACT

A method for building an Extended Filesystem (Ext) on a mass storage device includes the step of calculating parameters of the Ext by processing attributes that are common to a type of the Ext. Metadata common to the type of Ext is generated using the calculated parameters, in a metadata processing stream. A data structure for the Ext is written using the metadata generated in the metadata processing stream, in a data block processing stream.

### FIELD OF THE INVENTION

The invention described herein relates to a method and to a system for building an Extended Filesystem (Ext).

### BACKGROUND OF THE INVENTION

Organising information within a single contiguous medium can require complex information organisation structures to access information for editing, for example. A filesystem on a mass storage device is one such complex information organisation structure.

File systems are commonly designed to store redundant metadata to accommodate hardware or software failures. They are usually optimised so that simple operations can succeed regardless of their current state or contents. Therefore, conceptually minor changes to the data stored within the system can require complex event chain reactions such that orders of magnitude more data than the changed data is affected. For example, changes to data in one location commonly require further changes in hundreds or thousands of other locations.

The family of Extended Filesystems (Exts) are in common use and can provide effective ways of performing individual operations on existing data. However, generating an entire Ext image from scratch, complete with files, reveals performance shortcomings that perhaps were not foreseen in the original design of that filesystem.

The Second Extended Filesystem (Ext2) is a significant rewrite of the earlier Extended Filesystem and was released to the public as part of the Linux (trade mark) kernel. It can extend filesystem functionalities while maintaining the internal structures of the filesystem. The Third Extended Filesystem (Ext3) and the Fourth Extended Filesystem (Ext4) have also been developed. However, Ext2 forms the basis of such further file systems, which add a few further options, including journaling, journal checksums, extents, online defragmentation, delayed allocations and larger directories.

Ext2 and descendants use blocks as the basic unit of storage and inodes to keep track of files and system objects. Block groups are used to split the disk logically into manageable sections. Directories are used to provide a hierarchical organisation of files, blocks and inodes. Superblocks define the parameters of the filesystem and its overall state.

Filesystems, such as Ext2, can be built during a high-level formatting process that creates the filesystem within a disk partition or a logical volume. This formatting includes the data structures that are used by the operating system (OS) to identify the logical drive or partition contents. This can occur during OS installation or when adding a new disk.

The logic that is used for building filesystems from scratch is the same logic that would be applied when building filesystems with data files. For example, a filesystem being created with a dozen files would be created by performing the same sequence of operations on the data as would be done to create an empty filesystem. Each file is then added, one by one, a dozen times. Writing the data in this way is cheap in terms of “developer-hours” because it is based on simple, existing, and proven logic, but it can be “expensive” in terms of the number of operations required to achieve a completed filesystem.

The data cannot be written in a single sequence using the current logic. Rather, the final state of the data must be built up in steps and to do this, one of two approaches is necessary:
1. Allocate enough system memory to construct the entire data structure. Have the data built in steps using this data structure. Then write the built data into the system memory according to that data structure. This approach is sufficiently fast, but the minimum amount of memory required cannot be less than the finished size of the entire uncompressed filesystem. For many applications, it is not unreasonable to require filesystems that are many gigabytes large. Consuming gigabytes worth of RAM is not acceptable in most applications.
2. Use a temporary file on the system's storage device to store the data as it is being built, instead of allocating system memory to construct the data structure in RAM. However, hard disk operations are comparatively slow compared to operations in RAM, particularly since they are themselves written onto an active filesystem, compounding the cost of each operation. Also, the filesystem needs enough free space to contain the full size of the uncompressed virtual disk.

The following is an example of the management of data when a 1 KiB file is added to a 1 GiB Ext2.

The Ext2 is divided up into block groups of equal length and each no more than 8 MiB in size. There must be at least 128 different block groups for a 1GiB Ext2. It is necessary to find a single available inode and a single free block (assuming the Ext2 uses 1 KiB blocks). Here is a typical step-by-step process for achieving this.
1. Read metadata from the “superblock” (Block 1) to learn how many inodes and blocks are available on filesystem and to learn the size of each block group.
2. Read metadata from the “block group descriptor table” (blocks 2-5) and iterate through the table to find a block group with an available inode and a block group with an available block.
3. Read the “block usage bitmap” from a block group with an available block and iterate through the bitmap to determine the location of a free block. Reserve the free block by marking it as used in the bitmap.
4. Update the block group descriptor table and superblock to reflect that the block is no longer available. The superblock and block group descriptor table have redundant backups in every block group, so this step must be repeated 128 times in different places.
5. Read the “inode usage bitmap” from a block group with an available inode and iterate through the bitmap to determine the location of a free inode. Reserve the free inode by marking it as used in the bitmap.
6. Update the block group descriptor table and superblock to reflect that the inode is no longer available. The superblock and block group descriptor table have redundant backups in every block group, so this step must be repeated 128 times in different places.
7. Search for the inode of the parent directory by recursively reading inodes and then the blocks to which they point until the end of the parent's file path is reached. Every inode traversed along the way needs to have its Last Access Time updated. Here, assume that the file is being stored directly under the root directory.
8. Update the data of the parent directory so that it contains a directory entry for the new file. Here, assume that no additional data needs to be allocated for the parent directory during this setup.
9. Update the Last Access Time and Modification Time of the parent directory's inode.
10. Write to the reserved inode all metadata for the new file, including a pointer to the block that was reserved for the new file.
11. Write the file's data into the block that was reserved for it.
12. Update the Last Written Time in the superblock. The superblock and block group descriptor table have redundant backups in every block group, so the step must be repeated 128 times in different places.

According to the above process, at least nine different blocks need to be read, and 775 blocks need to be written. It is possible to combine many of those operations using simple caching mechanisms, but at least 262 different blocks need to be written by the time the Ext2 is updated.

The above process illustrates that many operations are required for writing a single small file to the Ext2. Furthermore, even a small file change results in data being changed all over the Ext2. Nearly all the changes made to the Ext2 are made to update metadata and redundant metadata.

### SUMMARY OF THE INVENTION

According to a first aspect of the invention, there is provided a method for building an Extended Filesystem (Ext) on a mass storage device with a data processing apparatus, the method including the steps of:
in a data block processing stream:
   calculating constant parameters of the Ext by retrieving and processing parameters that are common to a type of the Ext; and
   writing a data structure for the Ext to the mass storage device using the calculated parameters; and
in a metadata processing stream:
   generating metadata common to the type of Ext and associated with the data structure; and
   writing the metadata to the mass storage device for association with the data structure written in the data block processing stream.

The method may include writing a data input package using the constant parameters for input to a computer, machine or data processing apparatus configured to read the constant parameters in a streaming process.

The data input package may be written to contain files for storing on the mass storage device at the time of building the Ext.

The step of retrieving the parameters may include the step of retrieving the parameters from a metadata tree of the Ext.

The data block processing stream and the metadata processing stream may be carried out concurrently.

The step of writing the data structure in the data block processing stream may include writing an empty data structure for non-overhead data according to the calculated constant parameters.

The step of writing the empty data structure may include the step of writing empty data block groups, in a series of iterations, the number of empty data block groups being calculated in the step of calculating the constant parameters.

Each iteration may include the step of writing an empty data block and data describing characteristics and usage of the data block group.

The step of writing the data structure for the Ext may include the step of writing data blocks from a data blocks queue generated in the metadata processing stream.

The step of retrieving the metadata in the metadata processing stream may include the step of processing a metadata tree in a data input package.

The method may include the step of, for each node in the metadata tree, determining whether the node is a file and, if the node is a file, padding the file size to align with a pre-determined size of the data blocks, and writing the contents of the file to a data block input stream for the node, otherwise, if the node is not a file, generating directory entries from children of the retrieved node to be used in the data block input stream in the step of writing the data structure for the Ext, and in both cases, decrement a current file block by one.

The method may include the step of incrementing a current file block if not all data in the metadata tree has been written.

The method may include the step of generating pointer block data and writing the pointer block data to the data block input stream if a current file block is a pointer block, otherwise, if the current file block is not a pointer block, writing the incremented file block to the data block input stream.

According to a second aspect of the invention, there is provided a system for building an Extended Filesystem (Ext) on a mass storage device, the system including a data processing apparatus that is programmed with a set of computer readable instructions, which, when executed, cause the data processing apparatus to carry out the following steps:
in a data block processing stream:
   calculate constant parameters of the Ext by retrieving and processing parameters that are common to a type of the Ext; and
   write a data structure for the Ext to the mass storage device using the calculated parameters; and
in a metadata processing stream:
   generate metadata common to the type of Ext and associated with the data structure; and
   write the metadata to the mass storage device for association with the data structure written in the data block processing stream.

According to a third aspect of the invention, there is provided a non-transitory computer readable medium carrying a set of computer readable instructions, which, when executed by a data processing apparatus, causes the data processing apparatus to carry out the following steps:
in a data block processing stream:
   calculate constant parameters of the Ext by retrieving and processing parameters that are common to a type of the Ext; and
   write a data structure for the Ext to the mass storage device using the calculated parameters; and
in a metadata processing stream:
   generate metadata common to the type of Ext and associated with the data structure; and
   write the metadata to the mass storage device for association with the data structure written in the data block processing stream.

### BRIEF DESCRIPTION OF THE DRAWINGS

FIG. 1 shows a top-level diagram illustrating a method for building a filesystem with a data processing apparatus.

FIG. 2 shows a diagram illustrating a data block processing stream for a method of building an Ext2 with a data processing apparatus.

FIG. 3 shows a diagram illustrating a metadata processing stream for a method of building an Ext2 with a data processing apparatus.

FIG. 4 shows a layout of an input data package and an Ext2 built with a data processing apparatus using the input data package.

FIG. 5 shows a system for building a virtual disk having an Ext2.

### DETAILED DESCRIPTION OF EMBODIMENTS

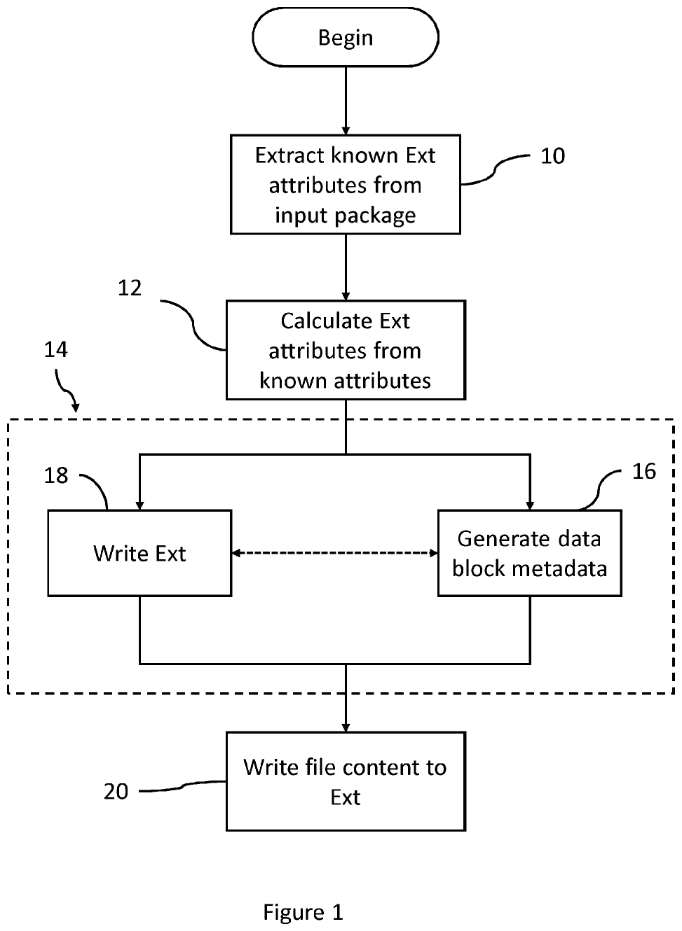

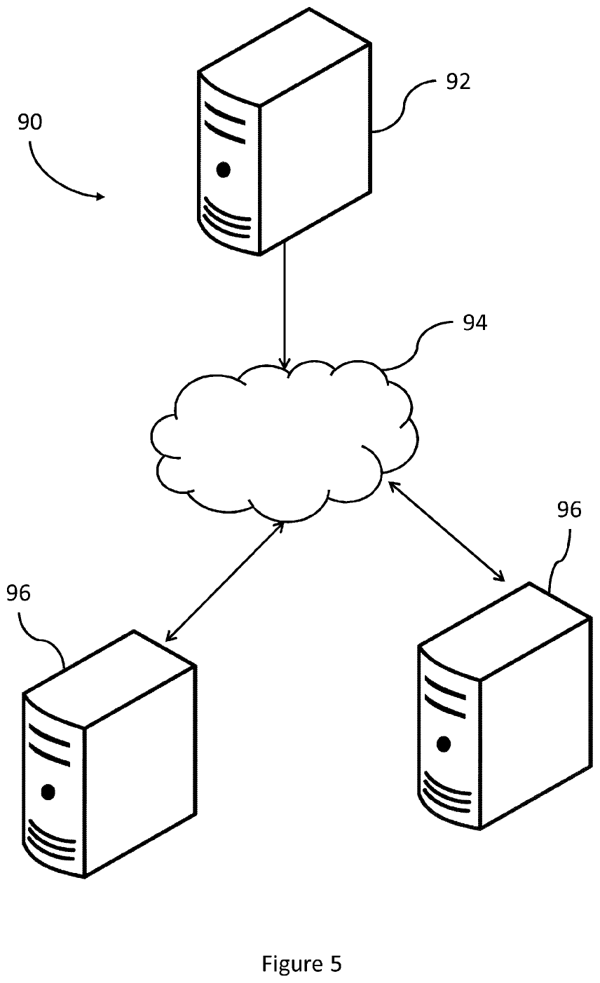

In FIG. 1, there is shown a top-level diagram illustrating a method for building an Ext with a data processing apparatus. The data processing apparatus can be in the form of a computer (including a network of computers), a server, or some other machine capable of carrying out data processing operations. For example, such a machine might be a host machine described below with reference to FIG. 5.

In this example, the Ext is an Ext2. It will be appreciated that the method could be used for further developments of the Ext2, including Ext3 and Ext4. The Ext in this embodiment is written on a virtual disk. It can thus run on a virtual operating platform provided by a hypervisor running on the data processing apparatus.

Known attributes or parameters of the Ext2 are read from a data input package at 10 by the data processing apparatus. The data input package can be a compressed file. The data input package can also contain file contents to be written to the Ext2 after it has been built.

The file contents can be in the form of code that defines a virtual disk having a master boot record (MBR), a configuration data section, an operating system kernel section and an application section. The virtual disk can be the virtual mass storage device as described in Australian patent application 2018902084 filed on 10 Jun. 2018, the contents of which are incorporated herein by reference. The file contents can be configured so that the operating system kernel section is in the form of a flat binary file. The virtual disk can be executed by guest machines referred to below in FIG. 5.

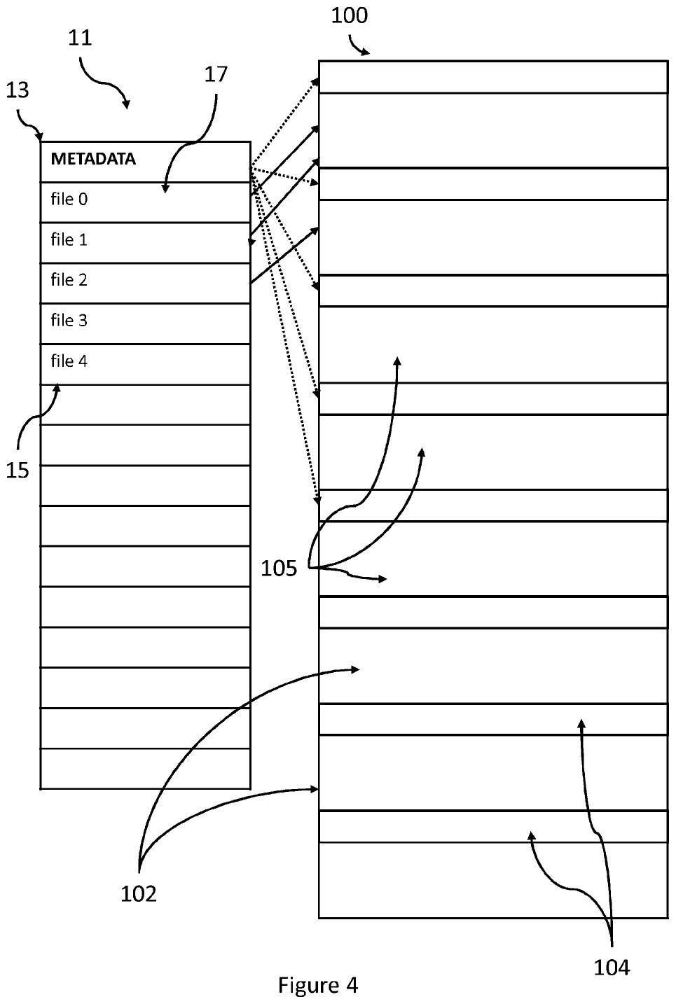

In FIG. 4, reference numeral 11 generally indicates a layout of the data input package. The data input package 11 includes a metadata section 13, for use in the method for building the Ext2. The package also includes data files 15, for writing sequentially to the Ext2 according to metadata, such as addresses, written to the Ext2 from the section 13. As will be seen below, the data input package is broadly divided into two parts arranged one after the other. The first part is a metadata tree (section 13), which is a collection of metadata about the files including file name, file size, and where the file sits within the tree, that is, what the file is the child of and what children it has. The second part is a flat table 17 of the files 15 themselves, stored in the order that those files would be encountered in a depth-first traversal of the metadata tree. This allows the files to be read sequentially, for example, in a streaming process without the need for seeking or other sub-processes. As mentioned above, the files 15 can be configured to define a virtual disk having an MBR, a configuration data section, an operating system kernel section and an application section. The files 15 can be Executable and Linkable Format (ELF) files that define the kernel section and the application section mentioned above and, for example, described in Australian patent application 2018902084.

The known attributes or parameters are those which are known to be associated with the Ext2. For example, they include the total number of blocks on the filesystem and the total number of inodes on the filesystem. They also include the magic number for the Ext2. It is possible to calculate, at 12, at least the following attributes or constant parameters from the known attributes:
1. total number of block groups,
2. number of blocks per block group,
3. number of inodes per block group,
4. block address of every superblock and redundant superblock,
5. block group descriptor tables,
6. block usage bitmaps,
7. inode usage bitmaps,
8. inode descriptor tables.

These attributes are stored as metadata in the section 13.

Generally, reference numeral 14 indicates a process for generating a virtual disk or virtual storage containing the Ext2 from the attributes calculated at 12, by a data processing apparatus. The process 14 includes two concurrent streams, namely a metadata processing stream at 16 and a data block processing stream at 18. The metadata processing stream 16 generates metadata in the form of data block metadata. The data block processing stream 18 writes an empty data structure for the Ext2 using the block metadata. Once the empty filesystem is written, it can be written to a mass storage device at 20, together with file content, in the form of the files 15, to be stored on the mass storage device. The data structure in the form of the empty filesystem and the file content can be written to the mass storage device in a data processing stream.

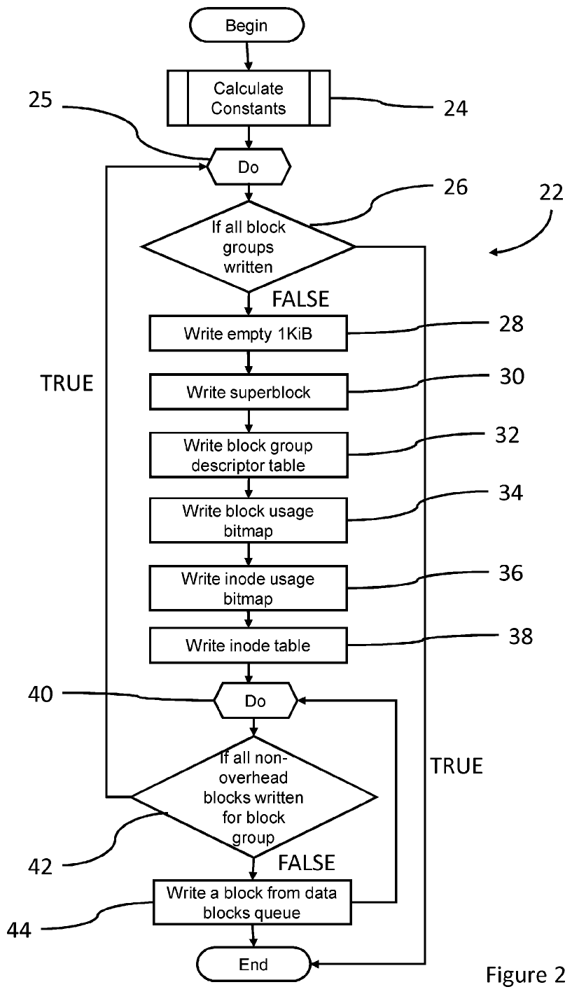

In FIG. 2, reference numeral 22 generally indicates the processing stream 18 in more detail.

The calculation described above at 12 is carried out at 24.

As is known, a superblock is a record of the characteristics of an Ext, which include the attributes listed above. The superblock also needs to contain a record of the total number of unallocated blocks and the total number of unallocated inodes. The calculation carried out at 24 generates values or constants for the Ext2 that can form the records for one or more superblocks of the Ext2 to be written. The calculation carried out at 24 is described below.

Calculating Values for Ext2 Metadata

In the following paragraphs, there is set out a description of processes executed by the data processing apparatus, for example the host machine described below, used to calculate values for the input data package. The values are calculated from the known values described above and stored as metadata in the section 13 (FIG. 4) for use in the process 14. In this embodiment, the values are those for an Ext2. It will be appreciated that this is for the purposes of illustration and, where practical, a person skilled in the art will be able to use much of the following description to obtain data for an input data package for building other forms of filesystem.

The algorithms and processes described below require certain arguments that are not or cannot be deduced. These are:
total_inodes: the total number of inodes available to the Ext2, which is closely related to the maximum number of files and directories that can exist on the Ext2.
total_blocks: the total number of blocks used by the Ext2, which can be multiplied by block_size to determine the total capacity of the filesystem.
block_size: the size of each block used by the filesystem, which is typically 1 KiB or 4KiB; in this description a value of 1 KiB should be assumed.

The Ext2 has a metadata tree that can be analysed to obtain the data for the data input package. The metadata tree can be completely traversed to determine the total number of files by counting file nodes and to determine the total number of directories by counting directory nodes. The metadata tree can be in the form of a data input package that is prepared for efficient traversal, such as sequential traversal.

It is necessary to calculate a total number of unallocated blocks. Broadly, this involves taking the total number of blocks and subtracting all the blocks that will be used. However, accounting for all the blocks can be tedious.

Initially, it is necessary to determine how many blocks are used by block group overhead. As is known, each block group includes overhead in the form of a redundant superblock, a descriptor table for the redundant superblock, an inode table, a block usage bitmap and an inode usage bitmap. The two bitmaps are always a single block each. The superblock is always a single block unless the block size is smaller than 2KiB. In that case, the superblock is the number of blocks required to be 2KiB in size. In this embodiment, a block size of 1KiB is used. This means that each redundant superblock occupies 2 blocks. Furthermore, the superblock is always offset from the start by 1 KiB.

Thus, the function for calculating the number of blocks required for the block group overhead is:

block_group_overhead=2+blocks_per_block_group_descriptor_table+blocks_per_inode_table+1+1

The blocks_per_inode_table is possible to determine only after inodes_per_block_group has been calculated. Each inode requires 128 bytes, and the number of blocks per inode table must be able to contain all the inodes per block group, rounded up.

The blocks_per_block_group_descriptor_table is possible to determine only after the block groups has been calculated (see inodes_per_block_group and blocks_per_block_group). For every block group, 32 bytes is needed within the block group descriptor table. The number of blocks per block group descriptor table must be able to contain all the block groups, rounded up.

This leads to:

block_group_overhead=1+CEILING(32*block groups/block_size)+CEILING(128*inodes_per_block_group/block_size)+1+1

A next step is to determine how many blocks will be needed to be used in each space that is not occupied by block group overhead. This is carried out by traversing the metadata tree and calculating the total number of blocks that will be needed for each file and directory. The number of blocks for files and directories are calculated differently. However, both are subject to inflation beyond the number of blocks needed just to store their real data, because larger files need to have block pointer blocks or indirect blocks added.

For files, a baseline number of blocks is found by a total size of the file, which is a parameter that can be obtained from the metadata tree, divided by the block size and rounded up.

A directory is effectively a specialised type of file. The contents of the file is a linked list of values including all the children of the directory. By including each of the children of a directory node from the metadata tree, it is possible to generate the information that would be stored within the directory. That can then be divided by the block size to determine a baseline number of blocks needed to store that information. At this stage, rounding up is not necessary because the restrictions on directory contents ensure that the size will be an exact multiple of the block size.

It is necessary to expand a baseline number of blocks for files and directories. This can be done using the following logic:

```
actual = baseline
leftover = baseline
blocks_per_indirect = block_size / 4
// singly indirect block pointer
baseline -= 12
if baseline > 0 {
  actual++
  baseline -= blocks_per_indirect
}
if baseline <= 0 {
  return
}
// doubly indirect block pointer
actual++
// doubly indirect block pointer's singly indirect blocks
for (i = 0; i < blocks_per_indirect; i++) {
  actual++
  baseline -= blocks_per_indirect
  if baseline <= 0 {
    return
  }
}
// triply indirect block pointer
actual++
// triply indirect block pointer's doubly indirect blocks
for (i = 0; i < blocks_per_indireet; i++) {
  actual++
  // triply indirect singly indirect blocks
  for (j = 0; j < blocks_per indirect; j++) {
    actual++
    baseline -= blocks_per_indirect
    if baseline <= 0 {
      return
    }
  }
}
return
```

The above logic can be applied to every single node within the metadata tree. The sum of the results can then be taken to determine the total number of non-overhead (data) blocks needed. Thus, the total number of unallocated blocks can be represented as follows:

unallocated_blocks=total_blocks−(block_groups*block_group_overhead+total_data_blocks)

Calculating the total number of unallocated inodes is carried out by subtracting the total number of nodes in the metadata tree, which is the combined total number of files and directories, from the total number of inodes. Subsequently, a further nine needs to be subtracted; the first ten inodes on the filesystem are reserved, but the second inode is reserved for the root directory, which is part of the metadata tree. This is represented as follows:

total_unallocated_inodes=total_inodes−(total_files+total_directories)−10+1

A block number of the block containing the superblock changes with each copy of the superblock because this field points at the address of the current superblock. It can be calculated by multiplying the number (n) of blocks per block group by the number of the current block group and adding the offset of the superblock within that block group. This is represented as follows:

block_number_of_block_containing_superblock=n*blocks_per_block_group+1

The number of blocks per block group and a number of inodes per block group also require calculation. These are two fields, but they are calculated at the same time because they are interdependent on each other. The first step in the calculation is to determine how many block groups there should be on the Ext2.

Each block group can have at most eight times the number of bytes per block because of the limited number of bits in the block usage bitmap. For a 1KiB block size, this means a maximum of 8192 blocks per block group, or 8MiB. Initially, to determine a total number of block groups, a lower bound is placed on what that number might be by taking the total number of blocks and dividing it by the maximum number of blocks per block group, rounded up. This is represented as follows:

lower_bound_0=CEILING(total_blocks/(8*block_size))

Each block group can have at most eight times the number of bytes per block inodes for the same reasons as explained with the blocks above. Thus, a further step in determining the total number of block groups is to put a lower bound on the number of block groups necessary to accommodate the total number of inodes (total_inodes).

lower_bound_1=CEILING(total_inodes/(8*block_size))

With both lower bounds calculated, the higher of the two values can be selected. For example, if ten block groups are required for the number of blocks, but twelve for the number of inodes, then twelve blocks are required. This is how the number of block groups (block groups) is calculated.

The number of blocks per block group and the number of inodes per block group can be calculated using the total number of block groups. This calculation could be done in several ways. One way would be to divide the total by the number of block groups and round up. This can be represented as follows:

blocks_per_block_group=CEILING(total_blocks/block_goups)

inodes_per_block_group=CEILING(total_inodes/block_goups)

The block address of the block usage bitmap can be calculated in a similar way to the calculation for block number of block containing superblock. This is the block group number multiplied by the number of blocks per block group, with an offset applied. The offset is dependent upon the size in blocks of the block group descriptor table and inode tables, as well as the size in blocks of the superblock. The calculation of these values is described above.

The block address of the inode usage bitmap is the above value, plus 1.

The starting block address of the inode table is calculated using similar logic to the calculation used for the block usage bitmap.

The number of unallocated blocks in a group can be calculated starting with the fact that every block group starts with a fixed number of blocks (blocks per block group). The block_group_overhead is subtracted from this number. Then, we need to subtract the number of data blocks used within this block group. This can be represented as follows:

block_group_data_capacity=blocks_per_block_group−block_group_overhead

block_group_of_last_data_block=FLOOR(total data blocks/block_group_data_capacity)

data_blocks_used_within_last_used_block_group=total_data_blocks % block_group_data_capacity

If this entry in the descriptor table is less than block_group_of_last_data_block, then there are no unallocated blocks in the group. If this entry in the descriptor table is greater than block_group_of_last_data_block, then the number of unallocated blocks in the group is block_group_data_capacity. Otherwise, the number of unallocated blocks in the group is

block_group_data_capacity−data_blocks_used_within_last_used_block_group.

If this is the final block group, it may be necessary to subtract extra blocks because the proper size of the block group theoretically extends beyond the boundaries of the filesystem (for example, the block groups are 8MiB and the Ext2 is 10MiB, such that the second block group needs its last 6MiB of data ‘reserved’ to signify that nothing can be written there).

The number of unallocated inodes in each block group has a similar value. However, the calculation is simpler because there is no overhead to be considered. This can be represented by:

block_group_of_last_inode=FLOOR(total_inodes/inodes_per_block_group)

inodes_used_within_last_used_block_group=total_inodes % inodes_per_block_group

If this entry in the descriptor table is less than block_group_of_last_inode then there are no unallocated inodes in the group. If this entry in the descriptor table is greater than block_group_of_last_inode then the number of unallocated inodes in the group is inodes_per_block_group. Otherwise, the number of unallocated inodes in the group is

inodes_per_block_group−inodes_used_within_last_used_block_group

If this is the final block group, it may be necessary to subtract some extra inodes for the reason set out above with respect to blocks.

To determine the number of directories in a block group we need to decide upon the metadata tree traversal order and use this order to determine which files and directories will be assigned to each inode, remembering that inodes start at 1 (not 0), that the root directory must be inode 2, and remembering that the first ten inodes are reserved. This involves counting the metadata tree nodes that represent directories for the inodes that will be kept in a given group.

The number of the block usage bitmap is calculated in a manner that is almost identical to the manner of calculating the number of unallocated blocks in the group. The main difference is that instead of calculating a final number, bits are marked as either used or unused in the bitmap. This is relatively simple because the relevant data space is being filled sequentially. If the block_group_overhead bits at the start of the bitmap are marked as full, then a bit for every data block that will be used within the block group is marked as full.

Any reserved space must be marked as “in use”. For example, if 6MiB block groups are used and the block size is 1KiB, then the bitmap can represent 8MiB of blocks and the 2MiB at the end of the bitmap should be marked as full.

The inode usage bitmap is handled in a similar manner.

The entries for the inode table must be able to point to the precise location of its contents although the contents have not yet been written. Aside from block addresses, all the information within an inode should be read directly from the metadata tree.

During the calculation of the total number of unallocated data blocks, information related to each of the data blocks is stored in a table. Thus, for any given inode number, the associated stored data can be looked up within this table to determine: (a) the expanded size of the file (or directory), and (b) the total number of data blocks that came before the data in this file.

An iteration is carried out through each block that a file will need. Blocks that are not blocks that require pointing at by an inode are skipped. For the blocks that are pointed at directly, the data block number is translated to the actual block number on the Ext2 by determining which block group it exists within, and how many data blocks into its block group it exists within.

Building the Filesystem

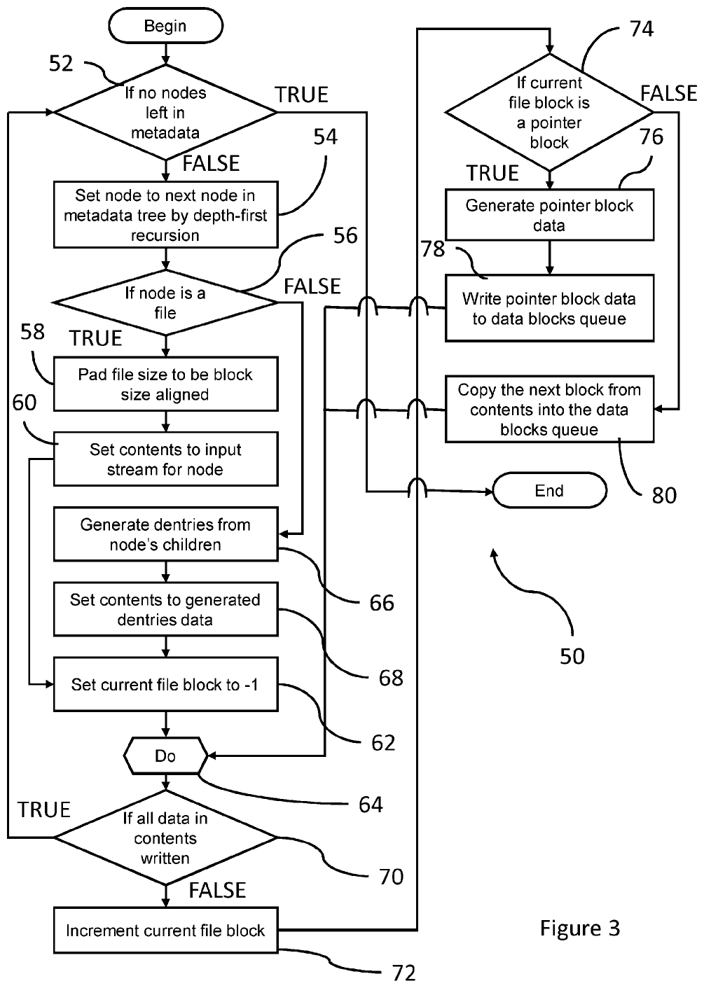

It is convenient to describe each of the processes shown in FIGS. 2 and 3 separately. However, these processes run concurrently so that the data block processing stream shown in FIG. 2 can use data generated in the metadata processing stream shown in FIG. 3 and made available in an input stream.

During the step shown at 24, the calculated constants or values are generated as described above under the previous heading. These constants are stored in a data input package in a predetermined manner for efficient retrieval. For example, they can be stored in the data input package in a sequential manner for retrieval in a streaming process without the need for seeking or other sub-processes required for identification and retrieval of the data.

As is conventional with Ext2, the non-overhead blocks are written into block groups, together with block group descriptor tables, block usage bitmaps, inode usage bitmaps, and inode descriptor tables for each block group. As is known, each block group in the Ext2 has block group descriptor tables, block usage bitmaps, inode usage bitmaps, and inode descriptor tables for redundancy.

At 25, a loop for writing block groups of the Ext2 is initialised. The data used for writing these block groups is retrieved from the data input package in a streaming process, as set out above.

At 26, the process queries whether all block groups, the number of which is calculated at 24, have been written.

The process writes a block group, as described below, if the query returns a false.

At 28, an empty 1 KiB block is written to provide the necessary offset for the superblock of the block group.

At 30, the process writes a superblock for the block group using the parameters or attributes retrieved from the data input package, as described above.

At 32, a data structure for block group descriptors is written after the superblock to describe each block group. The data structure is written using the attributes retrieved from the data input package. The data structure can be in the form of a block group descriptor table containing block numbers of the block groups.

At 34, a data structure for block usage is written after the block group descriptor table. The data structure is written using the attributes retrieved from the data input package. The data structure can be in the form of a block usage bitmap. The block usage bitmap is written as described above.

At 36, a data structure for inode usage is written after the block usage bitmap. The data structure is written using the attributes retrieved from the data input package.

The data structure can be in the form of an inode usage bitmap. The inode usage bitmap is written as described above.

At 38, a data structure for inode descriptors is written after the inode usage bitmap. The data structure is written using the attributes calculated at 24. The data structure can be in the form of an inode descriptor table. The entries for the inode table are calculated as described above.

At 40, a loop for writing non-overhead blocks of the Ext2 is initialised.

At 42, the process queries whether all the blocks for non-overhead data are written for the block group written in the previous steps.

The process passes to step 25 if the query at 42 returns a “true”. Otherwise, the process passes to step 44 where an overhead block is written from the data blocks queue set up in the processing stream 16.

The process ends if the query at 26 returns a “true”.

In FIG. 3, reference numeral 50 generally indicates the processing stream 16 in more detail.

The processing stream 50 is used to fetch nodes from a metadata tree of the data input package, determine the nature of those nodes and to write the data stored in the blocks for the nodes into a block input stream for use in building the Ext2. These can be in the form of actual file data blocks, direct block pointers, singly indirect block pointers, doubly indirect block pointers, etc.

The metadata tree can be configured so that the nodes can be fetched sequentially from the metadata tree without the need for seeking or carrying out other sub-processes, as mentioned above. Thus, the nodes in the metadata tree can be fetched in a streaming process. The streaming process can be any number of processes. One example is depth-first recursion in which each node is set to the next node during the process.

At 52, the process queries whether there are any nodes left in the metadata tree. If nodes remain in the metadata tree, the node is set as a next node in the metadata tree for the Ext2.

Nodes in the metadata tree can be files or directories depending on the functionality of the nodes. At 56, the process determines whether the retrieved node is a file or a directory. As is known, in Linux (trade mark), a directory is a special type of file. However, for convenience, “file” should be regarded as a data file.

If the query returns “true”, the process pads the file at 58 to bring the size of the file into alignment with a predetermined size of the blocks. Thus, in this example, the file is padded to 1 KiB. At 60, the contents of the file from the input stream are written to the current file data block. Then, at 62, the number of file data blocks available for the Ext2 is decremented by 1 and a data block queue is updated at 64 for step 44 of the processing stream 22

At 66, the process generates directory entries (dentries) for children of the retrieved node if the query at 56 returns “false”. Then, at 68, the process updates dentries data for the processing stream at 16 for generating block metadata. The process then moves to the step at 62.

At 70, the process queries whether all the data in the file contents has been written to data blocks. At 72, the process increments a current file block by one if the query at 70 returns “false”. Otherwise, the process returns to the query at 52 if the query at 70 returns “true”.

At 74, the process queries whether the current file block is a block containing pointers (a pointer block). If the query returns “false”, the process copies, at 80, a next file data block from the file contents into the data blocks queue for step 44 of the processing stream 22. If the query returns “true”, the process generates data for the pointer block at 76. At 78, the process writes the data for the pointer block to the data blocks queue.

If the query at 52 returns “true”, that is, if all the nodes in the metadata tree have been fetched or retrieved, the process 50 ends.

The result of the processes described above is represented in FIG. 4. Reference numeral 100 shows the Ext2 layout as series of block groups 102, only a few of which are shown. Each block group 102 has a header 104. The headers 102 are written with metadata in the form of overhead blocks generated in the process 50. The headers 102 are written in a streamed fashion as the process 22 writes the overhead blocks from the data blocks queue populated by the process 50. Each block group 102 has a data area or region 105. These can be populated by the data files, file 0, file 1, file 2, etc. as shown in FIG. 4, using the metadata in the headers 104 in a sequential manner. It follows that the Ext2, together with content data, can be written in a streaming process.

Applicant submits that the method and system described herein is an improvement over existing filesystem building processes in terms of processing time. The provision of the filesystem input package with the streaming processes described above optimises the use of computing resources while producing large virtual disks. The methods described above result in data being written to an Ext2 (or other Ext) building process that does not require seeking processes, creation of temporary files, or caching the entire data within memory. As a result, computational load is minimised. The reason for this is that the data can be provided in the order consumed by the algorithms governing the processes described above. Thus, it is possible to host the algorithms on a virtual machine that is significantly smaller than machines that are currently utilised for hosting filesystem building programs.

Applicant further submits that the methods described above can be used to generate virtual disks for initialising software applications. For example, the methods described above can be used to generate a disk layout as described in Australian patent application 2018902084.

In FIG. 5, reference numeral 90 generally indicates a networked system for building an Ext on a mass storage device. The system 90 includes a host machine 92 that is configured to host the method of building the Ext2, as described above. Thus, the host machine 92 is configured to host computer readable instructions, algorithms or processes illustrated in FIGS. 1 to 3. The computer readable instructions can be carried by a computer readable medium, such as a non-transitory computer readable medium, within the host machine 92. It will readily be appreciated that the host machine 92 can comprise one or more computers, servers and other data-processing machines or apparatus that can be networked together in a synergistic fashion.

The system 90 also includes a network 94. The network 94 can be any form of network, such as a LAN, WAN, the Internet, etc. Guest machines 96 can be operatively connected to the host machine 92 via the network 94.

The host machine 92 is configured to receive input data for the stream building algorithms described herein. For example, the host machine 92 can be configured to extract, in a streamed manner, the Ext2 attributes from the data input package and to calculate each attribute or parameter for the Ext2, as described above, for use in the stream building processes described above, also in a streamed matter.

The host machine 92 can be configured to stream data out over the network 94 to the guest machines 96 as the filesystems are built on the guest machines 96.

The appended claims are to be considered as incorporated into the above description.

It is to be understood that the terminology employed above is for description and should not be regarded as limiting. The described embodiments are intended to be illustrative of the invention, without limiting the scope thereof. The invention is capable of being practised with various modifications and additions as will readily occur to those skilled in the art.

1. A method for building an Extended Filesystem (Ext) on a mass storage device, with a data processing apparatus, the method including the steps of:
calculating parameters of the Ext by processing attributes that are common to a type of the Ext;
generating metadata common to the type of Ext using the calculated parameters, in a metadata processing stream; and
writing a data structure for the Ext using the metadata generated in the metadata processing stream, in a data block processing stream.

2. The method as claimed in claim 1, which includes the step of writing the data structure together with file content to a mass storage device in a data processing stream.

3. The method as claimed in claim 1, which includes retrieving the attributes from a data input package with a data processing apparatus configured to read the data input package in a streaming process.

4. The method as claimed in claim 3, in which the data input package contains files for storing on the mass storage device in accordance with the Ext.

5. The method as claimed in claim 4, which includes the step of retrieving the attributes includes the step of retrieving the attributes from a metadata tree of the Ext.

6. The method as claimed in claim 1, in which the data block processing stream and the metadata processing stream are carried out concurrently.

7. The method as claimed in claim 1, in which the step of writing the data structure includes writing an empty data structure for non-overhead data according to the calculated parameters.

8. The method as claimed in claim 7, in which the step of writing the empty data structure includes the step of writing a number of empty data block groups, in a series of iterations, the number calculated in the step of calculating the parameters.

9. The method as claimed in claim 8, in which each iteration includes the step of writing an empty data block and data describing characteristics and usage of the data block group.

10. The method as claimed in claim 1, in which the step of writing the data structure for the Ext includes the step of writing data blocks from a data blocks queue generated in the metadata processing stream.

11. The method as claimed in claim 1, in which the step of writing the data structure for the Ext includes the step of processing a metadata tree in a data input package.

12. The method as claimed in claim 11, which includes the step of, for each node in the metadata tree, determining whether the node is a file and, if the node is a file, padding the file size to align with a pre-determined size of the data blocks, and writing the contents of the file to a data block input stream for the node, otherwise, if the node is not a file, generating directory entries from children of the retrieved node to be used in the data block input stream in the step of writing the data structure for the Ext, and in both cases, decrement a current file block by one.

13. The method as claimed in claim 12, which includes the step of incrementing a current file block if not all data in the metadata tree has been written.

14. The method as claimed in claim 13, which includes the step of generating pointer block data and writing the pointer block data to the data block input stream if a current file block is a pointer block, otherwise, if the current file block is not a pointer block, writing the incremented file block to the data block input stream.

15. A system for building an Extended Filesystem (Ext) on a mass storage device, the system including a data processing apparatus that is programmed with a set of computer readable instructions, which, when executed, cause the data processing apparatus to carry out the following steps:
calculate parameters of the Ext by processing attributes that are common to a type of the Ext;
generate metadata common to the type of Ext using the calculated parameters, in a metadata processing stream; and
write a data structure for the Ext using the metadata generated in the metadata processing stream, in a data block processing stream.

16. A software product for building an Extended Filesystem (Ext) on a mass storage device, the software product including a computer readable medium carrying a set of computer readable instructions, which, when executed by a data processing apparatus, causes the data processing apparatus to carry out the following steps:
calculate parameters of the Ext by processing attributes that are common to a type of the Ext;
generate metadata common to the type of Ext using the calculated parameters, in a metadata processing stream; and
write a data structure for the Ext using the metadata generated in the metadata processing stream, in a data block processing stream.
